(19) United States
(12) Patent Application Publication
(10) Pub. No.: US 2019/0199156 A1
(43) Pub. Date: Jun. 27, 2019

(54) STATOR OF A THREE-PHASE ELECTRONICALLY COMMUTATED DC MOTOR

(71) Applicant: Bühler Motor GmbH, Nurnberg (DE)

(72) Inventors: Georg Bernreuther, Nurnberg (DE); Matthias Ahrens, Nurnberg (DE)

(73) Assignee: Bühler Motor GmbH, Nurnberg (DE)

(21) Appl. No.: 16/225,655

(22) Filed: Dec. 19, 2018

(30) Foreign Application Priority Data
Dec. 21, 2017 (DE) 10 2017 223 519.5

(51) Int. Cl. H02K 3/28; H02K 3/52; H02K 1/16; H02K 15/02; H02K 15/085

(52) U.S. Cl. CPC H02K 3/28; H02K 3/522; H02K 2203/06; H02K 15/024; H02K 15/085; H02K 1/16

(57) ABSTRACT

A stator of a three-phase electronically commutated DC motor, having a stator core, an insulating material body and a coil wire, wherein the stator core has a closed back iron and a plurality of stator poles pointing radially inwardly from the back iron, which contacts the insulating material body axially at the stator core, and covers both the back iron and also the stator poles. The stator is for a brushless DC motor designed in such a way that it is designed for a 48V on-board electrical system, being especially compact and nevertheless reliably preventing coil wires of different phases from touching each other and an economical production process being used.

### CROSS-REFERENCE TO RELATED APPLICATIONS

The present patent application is based on, and claims priority from, German Application No. DE 10 2017 223 519.5, filed Dec. 21, 2017, which is incorporated herein by reference in its entirety.

### BACKGROUND OF THE INVENTION

### (1) Field of the Invention

The invention relates to a stator of a three-phase electronically commutated DC motor, having a stator core, an insulating material body and a coil wire.

### (2) Description of Related Art Including Information Disclosed Under 37 CFR 1.97 and 1.98

An important application of such stators is brushless DC motors for motor vehicles with a dual-voltage on-board power supply. In many applications, the usual 12V is adequate as a supply voltage. Due to the increase in the number of consumers with higher energy requirements, such as main cooling water pumps, the introduction of an on-board electrical system with a higher voltage level will be indispensable in the future. It is likely that a 48V on-board electrical system in parallel with the existing 12V electrical system will prevail. In principle, the higher voltage causes less power to be consumed by the individual consumers. In electric motors, this means that smaller coil wires with a smaller wire diameter can be used. These have a relatively thin insulating layer. Due to imperfections in the lacquer insulation or abrasion due to micro-vibrations, short circuits can arise between coil wires of different phases and thus of different voltage potentials. This would result in failure of the affected electric motor.

### BRIEF SUMMARY OF THE INVENTION

The invention relates to a stator of a three-phase electronically commutated DC motor, having a stator core, an insulating material body and a coil wire, wherein the stator core has a closed back iron and a plurality of stator poles pointing radially inwardly from the back iron, which contacts the insulating material body axially at the stator core, and covers both the back iron and also the stator poles.

The present invention is aimed at three-phase internal-rotor motors, which are wound by a needle-winding method, in particular as brushless DC motors having a diameter of about 40 to 80 mm and a power range between about 300W and about 2 kW. When winding the stators, it is advantageous if the complete stator can be wound continuously without interruption with a single coil wire. In installing the wire on the stator, as a rule, up to four wires are laid in parallel. Wire crossings cannot be avoided either in a compact design. There is therefore the risk of contacts and thus of short circuits.

An object of the invention is a stator for a brushless DC motor designed in such a way that it is designed for a 48V on-board electrical system, being especially compact and nevertheless reliably preventing coil wires of different phases from touching each other and an economical production process being used.

In order to ensure defined conditions and the smallest possible movements of the coil wires both in the stator coils and in the connecting lines between the coils and between the phases, attention should be paid to ensuring an adequate wire tension. The geometry of the insulating material body also plays an essential role in this. In the case of connecting wires laid in a circular path, it is relatively easy to achieve a wire installation which is always play-free. For this reason, it is provided that phase wire sections are laid in wire guidance contours, which run along a circular path. Here the wire guidance contours should be designed such that no contacts are possible between phase wire sections laid in parallel around an annular wire guidance region or between skewedly crossing phase wire sections. Due to a helical course of a section of the wire guidance contours it is possible to shift the axial position of the coil wire by a contour level and achieve a compact structure.

A reliable separation of phase wire sections is provided when each phase wire section is guided in its own wire guide contour. These are separated from each other by a wall and even with a faulty wire insulation assure a short-free operation.

Depending on requirements, the wire guidance contour may also be interrupted without departing from the scope of protection of the invention. This relates in particular to an external distal wire guidance contour at the end of which a phase wire section is guided radially inwardly to a stator pole.

It is intended that the coil wires be always under mechanical tensile stress. This is effected on the one hand by the geometry of the wire guidance contours, which have a substantially circular course, as well as by a defined force with which the coil wire is kept under tension during the winding process. Here, areas with openings around the coil wire are to be avoided. In the optimal case phase wire sections run without play within the wire guidance contours. In this way no vibrations can arise and consequently no wire breaks will occur.

At various locations around the wire guidance region it may be necessary to depart from the circular shape of the wire guidance contours. This is often necessary in crossing areas or in places where other technical obstacles require the wire to be diverted.

In order nevertheless to maintain wire tension as strong as possible, this diversion is provided in the form of a chord, if at all possible, with continuous transitions between the circle segment and the chord section. Alternatively, a further circle segment with a significantly greater radius than the circumference may be provided instead of a chord section. In this case, wire tension is largely preserved.

Particularly advantageous are the above-mentioned deviations from the circular shape in regions in which an axially extending phase wire section skewedly passes radially externally a phase wire section of a different phase, said section running circumferentially. In the case of a wire guide contour optimally adapted to the wire diameter, short circuits can thereby be reliably avoided.

It is preferably provided that all axially extending phase wire sections skewedly pass radially externally a phase wire section of a different phase, said section running circumferentially. This is necessary when the phase wire sections are laid between the coils of the first winding phase in a first wire guidance contour, said contour being located at the outer axial end of the wire guidance region facing away from the stator, the second phase wire sections in an adjacent middle wire guidance contour and the third phase wire sections in a wire guidance contour close to the stator.

For the winding operation it is intended that the insulating material body have radially projecting permanent, removable or reversible deflectors. Permanent deflectors are to be provided when sufficient installation space can be made available. In a more compact design, the deflectors can after the winding process be severed, folded or bent, depending on the geometric design. This usually requires an additional process step, unless bending is performed during assembly of a housing.

It is intended here that a circumferentially laid phase wire section is guided at a deflector in an axial direction and crosses at least one axially adjacent wire guidance contour, which at this point has a non-circular section. The phase wire section guided in the axial direction here moves away from the stator. In this way the phase wire section running circumferentially will always deviate away from contact with a phase wire section running axially. The phase wire section running axially must also be guided by means of a wall between the phase wire sections, said wall having no recess. It is also conceivable that, in order to avoid an increase in diameter, the phase wire section running axially also be sunk into the wall between the wire guidance sections. In this case the deviation from the circular shape of the adjacent wire guidance contour would have to be implemented correspondingly more clearly in order to ensure a sufficient distance between the various phase wire sections.

A special feature of this invention is that at least some of the wire deflectors project radially between two wire guide contours. In this way, the phase wire sections can be laid more flexibly, so that it is also possible in a simplified manner to wind the complete stator continuously using a single coil wire.

Since the wire guide contours lie close together, the wire deflectors projecting radially between the wire guidance contours are radial extensions of walls between the wire guidance contours. So that the phase wire sections can be laid in the wire guidance contours it makes sense for the deflectors to be formed flat, like the walls.

In the embodiment of the insulating material body according to the invention, it is not necessary for the wire guidance contours to have slot-like wire feedthroughs passing through the wire guidance region. This permits a more stable design for the wire guidance region and a higher wire tension can be achieved.

It may be necessary for the insulating material body to have centering contours which correspond to corresponding contours of the stator and/or of a housing, wherein the centering contours have the shape of a recess. These centering contours hold the stator centered with respect to a housing or provide anti-rotation protection or serve for better positional assignment. Even on such centering contours, the insulation of the phase wire sections must not be impaired, so for this reason it is also provided here for the wire guidance contours in the region of the centering contours to have a recess whose depth is dimensioned such that a phase wire section can be completely accommodated therein, without protruding into the region of the centering contours.

Depending on space requirements, different embodiments of the insulating material body may be useful. If the diameter of the stator and thus of the DC motor is to be kept low, it is expedient for the annular wire guidance region to axially extend the insulating material body. If the axial installation space is limited, the annular wire guidance region can also radially expand the insulating material body.

The terminal projections in each case connect axially to the wire guidance region. These are designed in such a way as to have shaft-like housing contours for accommodating an insulation displacement contact, wherein slot-like radial recesses in the shaft wall are provided for receiving a radial phase wire section.

It is appropriately provided for limiting means to be present axially on the wire guidance region which are integral with the insulating material body and which prevent the radial phase wire sections from shifting or deflecting in the circumferential direction. As a result, the degrees of freedom of the wire become restricted and the oscillation tendency significantly reduced.

For structural reasons it is expedient for a wire guidance contour to have a leadout contour in one end region, whereby the wire guidance contour merges steplessly into a guide-free section of the wire guidance region. Before the leadout contour, flat deflectors are provided which facilitate a wire deflection. The wire guide contour then ends and merges with the leadout contour. The deflectors for the phase wire sections can be removed after winding, since as a result of the wire tension the coil wire can no longer escape from the wire guidance contours.

In many applications, such as electric oil pumps, a printed circuit board for electrically driving the motor is located near the winding circuit. In order to optimize the printed circuit board layout, it is advantageous for the phase connections to lie close to one another, preferably in an angular range of not more than 120°.

The stator and an electric motor with this stator are preferably designed for an on-board power supply voltage of 48V, with a voltage range of 24V to 60V or 36V to 60V or 40V to 60V.

The stator is designed for an on-board power supply voltage of 36V, with a voltage range of 24V to 48V or for an on-board power supply voltage of 110V, with a voltage range of 90V to 150V.

It is further provided that the energy for energizing the stator is supplied by a direct current source, by an alternating current source, by a three-phase current source or by a pulsed direct current.

The stator has a diameter in the range between 40 and 80 mm or between 40 and 160 mm or between 40 and 200 mm. Finally, the stator and an electric motor with this stator are designed for a power range between 300W and 2 kW or between 300W and 4 kW or between 300W and 6 kW. In addition, an electric motor with a stator according to any one of the preceding claims is claimed.

### BRIEF DESCRIPTION OF THE SEVERAL VIEWS OF THE DRAWINGS

The exemplary embodiments of the invention are subsequently further explained, based on the drawings. The following is shown:

FIG. 1 is a view of a stator from the prior art,

FIG. 2 is a first embodiment of a stator according to the invention,

FIG. 3 is a side view of an insulating material body with wire installed,

FIG. 4 is a detail of the insulating material body with intersecting wire feeds,

FIG. 5 is the stator wound with a first phase,

FIG. 6 is the stator wound with the first and a second phase,

FIG. 7 is the stator wound with the first, the second and a third phase,

FIG. 8 is a further detail showing deflectors,

FIG. 9 is a partial view of the insulating material body with deflectors,

FIG. 10 is a second embodiment of stator according to the invention with a neutral point contact,

and

FIG. 11 is a winding diagram of the three phases.

Note: The reference numbers with index and the corresponding reference numbers without index refer to details with the same name in the drawings and the drawing description. The reference number list contains only reference numbers without index for the sake of simplicity.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

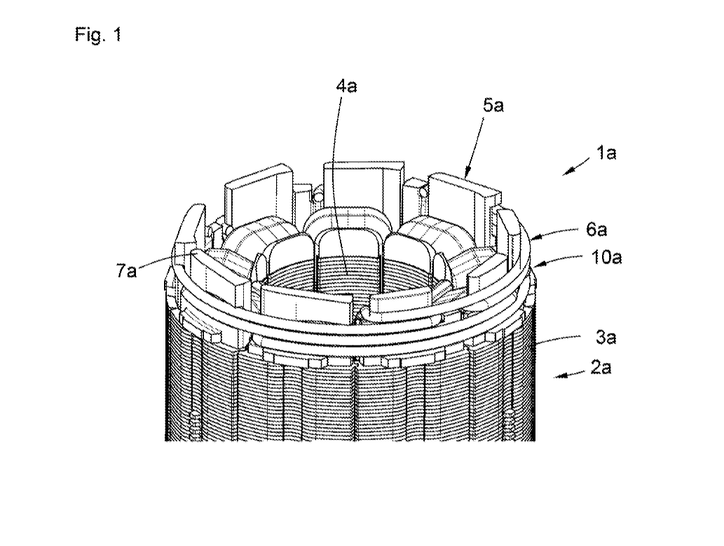

FIG. 1 shows a prior art stator 1a with a stator core 2a having a back iron 3a and stator poles 4a, an insulating material body 5a and a coil wire 6a. Although the insulating body 5a does include a wire guidance region 10a, the insulating body does not have adequate wire guidance contours. The up to four parallel connecting wires between the phases (phase wire sections 7a) may touch each other. The stator of a 12V motor, whose wire diameter is relatively large, is concerned here. Accordingly, the wire insulation is also relatively thick-walled and is generally adequate. Wire crossings are avoided in that the wire guidance region 10a is often interrupted by slots. The wall thickness must thus be increased accordingly in order to obtain sufficient stability.

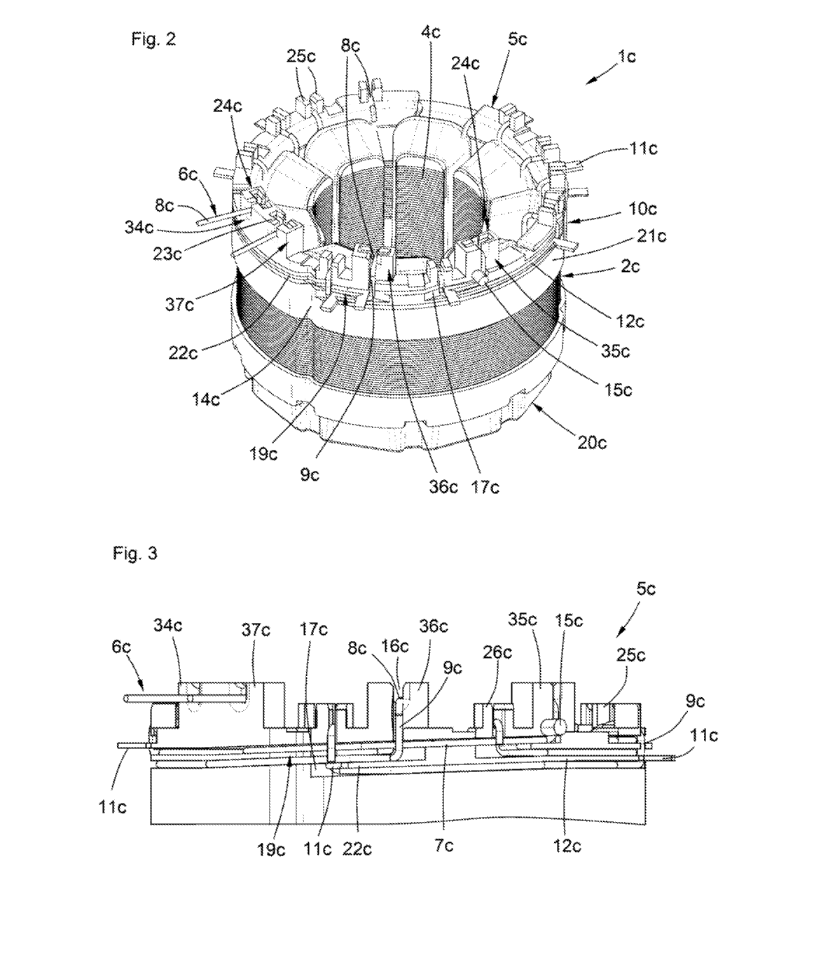

FIG. 2 shows a 3D illustration of a first embodiment of the stator 1c according to the invention, with a back iron 2c, radially inwardly projecting stator poles 4c, an insulating material body 5c, a coil wire 6c and an insulating cap 20c without a wire guidance function. The insulating material body 5c has an outer ring 21c pushed over the back iron 2c, an axially adjoining wire guidance region 10c and axially adjoining terminal projections 34c, 35c, 36c, 37c. The wire guidance region 10c has wire guidance contours 12c in the form of grooves formed in the wire guidance region 10c and separated from each other by walls 22c. The terminal projections 34c, 35c, 36c, 37c have shaft walls 23c, each forming a receiving shaft 24c for an insulation displacement contact. Two shaft walls 23c of the connecting projections 34c, 35c, 36c, 37c have in each case slot-like recesses 16c which serve to receive radially laid phase wire sections 8c.

Limiting means 25c that are integral with the insulating material body 5c axially adjoin the wire guidance region 10c and prevent radial phase wire sections 8c from shifting or deflecting, said limiting means leading not into one of the slot-like recesses 16c but rather to a coil of a stator pole 4c. To enable reliable installation of the coil wire during the winding operation, in particular when laying the circumferential wire section 7c by 90° in an axial direction (axial phase wire section 9c), flat deflectors 11c and cylindrical deflectors 15c are provided. If the deflectors 11c are arranged between two wire guidance contours 12c, they will be flat like the wall 22c and formed as an extension thereof. The flat geometry is required in order to enable installation of the phase wire section 7c into the wire guidance contour 12. Cylindrical deflectors 15c may be provided that are wider than the wall 22c when they are arranged at the axially outer end of the wire guidance region 10c. Furthermore, a helical section 19c of wire guidance contours 12 can be seen.

FIG. 3 shows a side view of the insulating material body 5c according to FIG. 2 with coil wire 6c laid thereon, in particular phase wire sections 7c. In one section 19c, a helical course of wire guide contours 12c can be seen here more clearly than in FIG. 2, this being provided in a transition region from a first to a second phase as well as from a second to a third phase. Furthermore, the wire guidance contours 12c, the walls 22c between the wire guidance contours 12c, the radially arranged flat deflectors 11c, the cylindrical deflectors 15c, the axially disposed limiting means 25c and the axially disposed terminal projections 16c can be seen to which the axially extending phase wire section 9c leads and in which the radially extending phase wire section 8c lies in the slot-like recess 16c. There are two single terminal projections 35c, 36c present and a double terminal projection 34c, 37c which receives the start and the end of the coil wire 6c. The limiting means 25c have oblique insertion regions 26c.

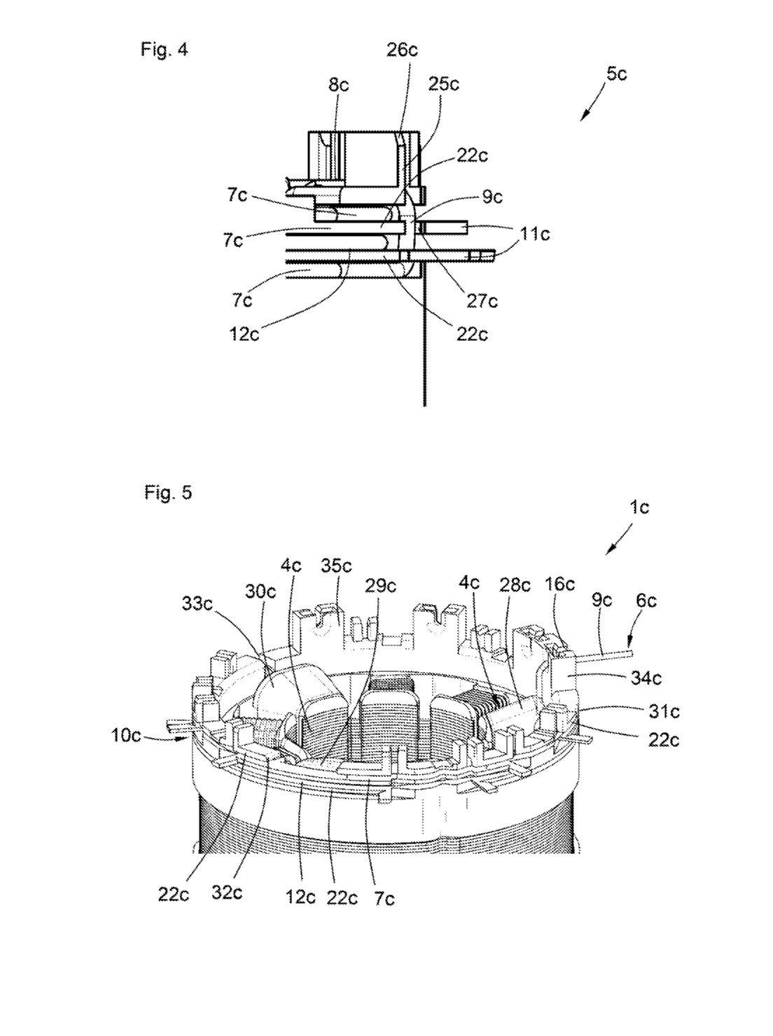

FIG. 4 shows a detail of the insulating material body 5c, with the wire guidance contours 12c, the walls 22c, the flat deflectors 11c, the limiting means 25c, with the oblique insertion regions 26c, the phase wire sections 7c running along a circumferential circle, the axially extending phase wire sections 9c and the radially extending phase wire sections 8c. The narrow contour of the flat deflectors 11c, which represent a radial extension of the walls 12c, can be clearly seen. The wire guidance contours 12c are groove-like recesses in the outer circumference of the insulating material body 5c. In the angular sectors, in which the axially extending phase wire sections skewedly cross each other, the phase wire sections are recessed in a chord-like configuration in order to ensure a safe distance from the crossing phase wire section. To prevent the latter from causing any increase in radial diameter, a wall 22c with a recess 27c is also provided. The recess 27c and the recess of the wire guidance contour are matched such that an adequate distance between the crossing phase wire sections is always ensured.

FIG. 5 shows the stator 1c wound with a first phase. The stator 1c has nine poles, with three poles in each case belonging to one phase. The coil wire 6c passes radially inwards through the slot-like recess 16c of the first terminal projection 34c to a first stator pole 4c, there forms the first coil 28c and is guided radially outwardly through a first opening 31c in the outer wall 22c and into the first wire guidance contour 12c. The opening 31c also extends axially through the wire guidance region 10c. Since the coil wire 6c cannot escape at the first opening 31c no additional deflector is required. The coil wire 6c is guided by the wire guidance contour 12c at a first edge of a second opening 32c to a further stator pole, where it forms the second coil 29c. The coil wire 6c is guided radially outwardly from the second coil 29c at a second edge of the second opening 32c and guided back to the outer wire guidance contour 12 and up to a third opening 33c. The coil wire 6c passes through the third opening 33c radially inwardly to a further stator pole and there forms the third coil 30c. From the third coil 30c the coil wire 6c is guided axially to the second terminal projection 35c (not shown in FIG. 5). The first phase of the coil wire 6c is thus laid.

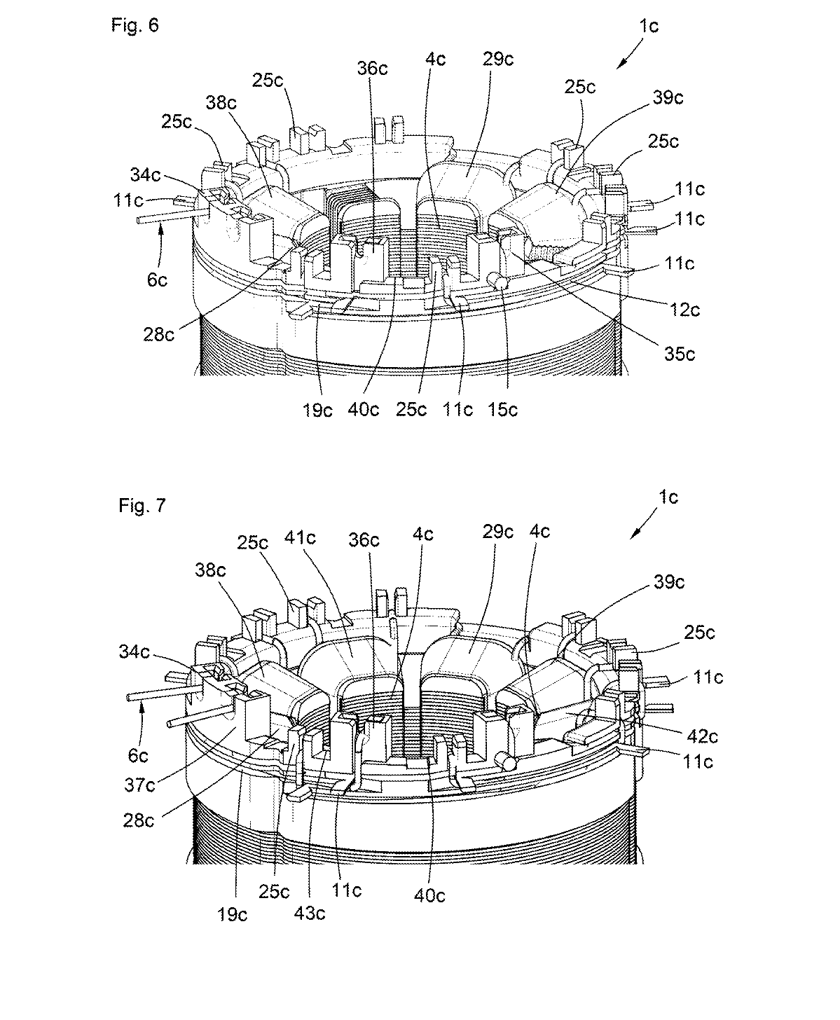

FIG. 6 shows the stator 1c wound with the first and second phases. The transition from the first to the second phase is at the second terminal projection 35c. From the second terminal projection 35c the coil wire 6c runs a short way axially to a cylindrical deflector 15c and from there, bending by about 90°, into the helical section 19 of the wire guidance contour 12c. As a result, the already occupied axially outer wire guidance contour 12c is bypassed. The helical section 19c passes into a wire guidance contour 12c parallel to the phase wire section 7c of the first phase (FIG. 5). At a flat deflector 11c the coil wire 6c is bent away at a right angle, guided axially and then radially over the outer wall 22c between two limiting means 25c and onward to a further stator pole. There the coil wire 6c forms the fourth coil 38c. From there the coil wire 6c runs again through two limiting means 25c back to the second wire guidance contour 12c (concealed) and from there in the same way onward through further limiting means 25c to a stator pole 4c. There the coil wire 6c forms a fifth coil 39c. From the fifth coil the coil wire 6c runs through further limiting means 25c again outwardly into the second wire guidance contour 12c (partially concealed), around a flat deflector 11c and then onward in the second wire guidance contour 12c. In the same manner a sixth coil 40c is formed. From there, the second phase is terminated with the passage through the third terminal projection 36c (not shown here).

FIG. 7 shows the stator 1c fully wound with three phases. From the third terminal projection 39c the coil wire 6c runs past a flat deflector 11c into a second helical section 19c of the wire guidance contour 12c, past the first coil 28c and the fourth coil 38c, around a deflector 11c (concealed) and through limiting means 25c to a further stator pole 4c to form a seventh coil 41c. From the seventh coil 41c the coil wire 6c runs radially outwardly and via a third wire guidance contour 12c which runs circumferentially to a flat deflector 11c and through limiting means 25c inwardly to a further stator pole 4c and there forms the eighth coil 42c. From the eighth coil 42c the coil wire 6c extends further radially inwardly around a flat deflector 11c via the third wire guide contour, then around a further flat deflector 11c to a further stator pole and there forms a ninth coil 43c. From the ninth coil 43c, the coil wire 6c runs directly to a fourth terminal projection 37c which together with the first terminal projection 34c forms a double terminal projection. In the present example the stator is delta-connected, the coil start therefore is connected to the coil end.

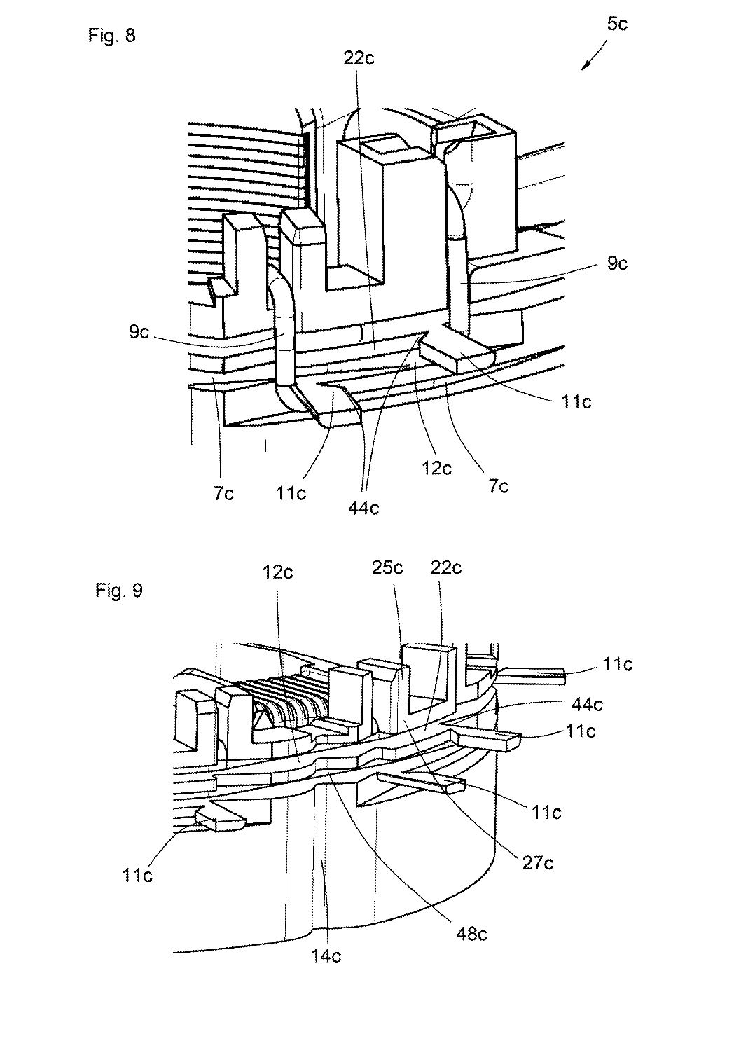

FIG. 8 shows another detail of the insulating material body 5c, with the wire guidance contours 12c, the walls 22c, the flat deflector 11c, the phase wire section 7c running along a circumference, the axially extending phase wire section 9c and predetermined breaking points 44c. The predetermined breaking points are of a notch-shaped design so that the flat deflectors 11c can be easily removed.

FIG. 9 shows a partial view of the insulating material body 5c with the deflectors 11c, the wire guidance contours 12c, the walls 22c, a centering contour 14c, chord-like recesses 48c, the recesses 27c, the predetermined breaking points 44c and the limiting means 25c. The chord-like recesses 48c serve at this point to lay the phase wire sections around the spatial region of centering means. The centering contour 14c also continues in the region of the walls 22c.

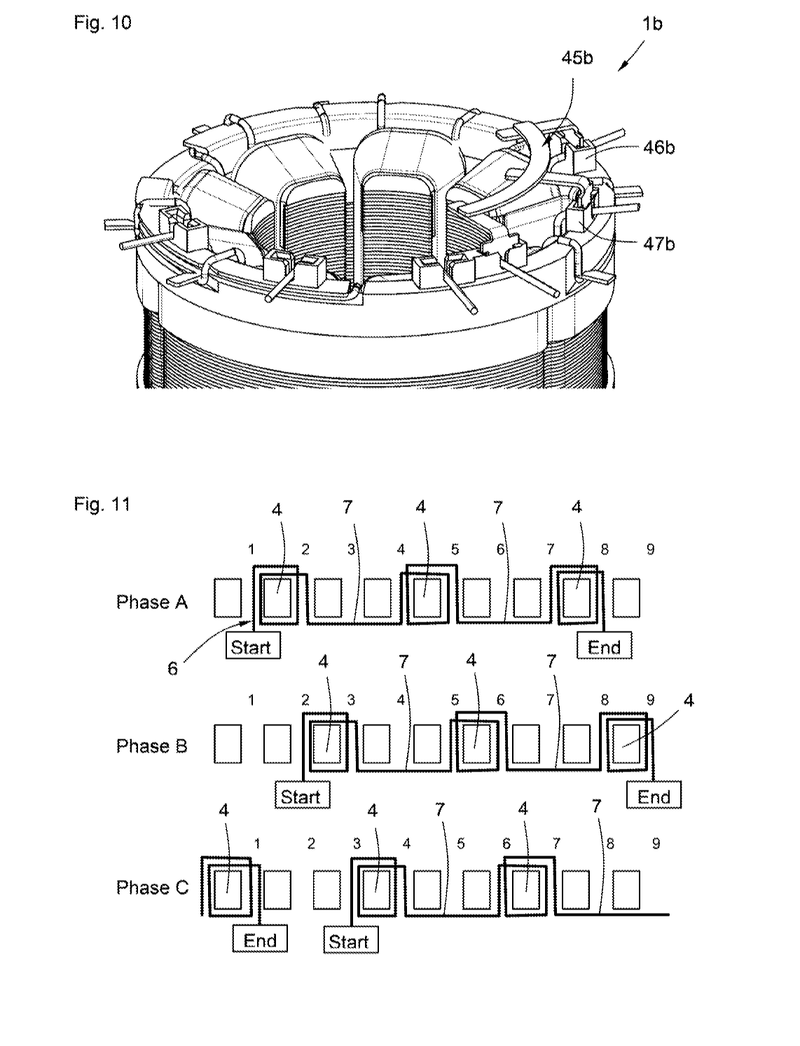

FIG. 10 shows a wound stator 1b with a neutral-point contact 45b. For this purpose, two additional terminal projections 46b and 47b are provided in order to connect the three phases to each another at a neutral point. In addition, the structure and the winding of the stator are similar to a stator with a delta connection.

FIG. 11 shows a winding diagram for the three phases A, B, C of the stator. The entire stator is wound with a single coil wire 6, starting with phase A by winding around a first stator pole 4, passing the coil wire onward through phase wire sections 7 past two unwound stator poles to a second stator pole 4 of phase A and in the same way to a third stator pole. Phase B starts with a pole offset from the starting point of the first phase and is continued in the same manner as in phase A. Phase C starts with a stator pole offset from the starting point of phase B and is wound analogously to phases A and B. The end point of phase C coincides with the starting point of phase A, resulting in a delta connection.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

1 Stator
2 Stator core
3 Back iron
4 Stator pole
5 Insulation body
6 Coil wire
7 Phase wire section
8 Radial phase wire section
9 Axial phase wire section
10 Wire guidance region
11 Flat deflector
12 Wire guidance contour
13 Deviating section
14 Centering contour
15 Cylindrical deflector
16 Slot-like recess
17 Leadout contour
18 Guide-free section
19 Helical section
20 Insulating cap
21 Outer ring
22 Wall
23 Shaft wall
24 Receiving shaft
25 Limiting means
26 Insertion area
27 Recess
28 First coil
29 Second coil
30 Third coil
31 First opening
32 Second opening
33 Third opening
34 First terminal projection
35 Second terminal projection
36 Third terminal projection
37 Fourth terminal projection
38 Fourth coil
39 Fifth coil
40 Sixth coil
41 Seventh coil
42 Eighth coil
43 Ninth coil
44 Predetermined breaking point
45 Neutral-point contact
46 Fifth terminal projection
47 Sixth terminal projection
48 Chord-like recess

What is claimed is:

1. A stator of a three-phase electronically commutated DC motor, the stator comprising:
a stator core having a closed back iron and a plurality of wound stator poles pointing radially inwardly from the back iron, the wound stator poles defining a plurality of phases;
an insulating material body surrounding both the back iron and the stator poles;
a coil wire which contacts the insulating material body axially at the stator core;
an annular wire guidance region defined on the insulating material body with radially outwardly open wire guidance contours extending substantially along a circular shape and partially helical in shape; and
a plurality of terminal projections on the annular wire guidance region,
wherein the coil wire is wound around the wound stator poles to define each phase and each phase has a phase wire section, wherein the phase wire sections run between the wound stator poles and are kept apart from each other by the wire guidance contours in such a way that no contact occurs between parallel-running and skewed-crossing phase wire sections of different phases.

2. The stator according to claim 1, wherein each phase wire section is guided in its own wire guidance contour.

3. The stator according to claim 2, wherein at least one of the wire guidance contours is interrupted in sections.

4. The stator according to claim 1, wherein there are a plurality of coil wires, and the coil wires are always under mechanical tensile stress.

5. The stator according to claim 1, wherein at least one of the wire guidance contours has a section that deviates from circularity.

6. The stator according to claim 5, wherein the deviation from circularity is chord-like or arc-like, and wherein the radius of the arc shape is greater than the radius of the circular shape of the insulating material body.

7. The stator according to claim 5, further comprising an axially extending phase wire section skewedly passing radially externally a phase wire section of a different one of the plurality of phases, the phase wire section running circumferentially.

8. The stator according to claim 7, wherein all axially extending phase wire sections skewedly pass radially externally a phase wire section of a different one of the plurality of phases, the extending phase wire section running circumferentially.

9. The stator according to claim 1, wherein the insulating material body has radially projecting deflectors.

10. The stator according to claim 9, wherein a circumferentially laid phase wire section is guided at a deflector in an axial direction and crosses at least one axially adjacent wire guidance contour, which at this point has a non-circular section.

11. The stator according to claim 10, wherein at least some of the wire deflectors project radially between two wire guidance contours.

12. The stator according to claim 11, wherein the wire deflectors projecting radially between the wire guidance contours are radial extensions of walls between the wire guidance contours.

13. The stator according to claim 12, wherein the wire deflectors are formed flat.

14. The stator according to claim 1, wherein the wire guide contours have no wire feedthroughs through the wire guidance region.

15. The stator according to claim 1, wherein the insulating material body has centering contours which correspond to corresponding contours of the stator and/or of a housing, wherein the centering contours have the form of a recess.

16. The stator according to claim 15, wherein the wire guidance contours in the region of the centering contours have a recess, the depth of which is dimensioned in such a way that a phase wire section can be completely accommodated therein, without protruding into the region of the centering contours.

17. The stator according to claim 1, wherein the annular wire guidance region axially extends the insulating material body.

18. The stator according to claim 1, wherein the annular wire guidance region radially extends the insulating material body.

19. The stator according to claim 1, wherein the terminal projections connect axially to the wire guidance region.

20. The stator according to claim 1, wherein the terminal projections have shaft walls with shaft-like housing contours for receiving an insulation displacement contact, wherein slot-like radial recesses are provided in the shaft walls for receiving a radial phase wire section.

21. The stator according to claim 1, further comprising limiting means provided axially on the wire guidance region and are integral with the insulating material body and prevent the radial phase wire sections from shifting or deflecting in the circumferential direction.

22. The stator according to claim 1, wherein at least one wire guidance contour has a leadout contour in one end region, whereby the wire guidance contour merges steplessly into a guide-free section of the wire guidance region.

23. The stator according to claim 1, wherein the terminal projections are arranged in an angular sector of not more than 120°.

24. The stator according to claim 1, wherein it is preferably designed for an on-board power supply voltage of 48V, with a voltage range of 24V to 60V or 36V to 60V or 40V to 60V.

25. The stator according to claim 1, wherein it is designed for an on-board power supply voltage of 36V or 110V, with a voltage range of 24V to 48V or of 90V to 150V.

26. The stator according to claim 1, wherein the power for energizing it is supplied by a direct current source, by an alternating current source, by a three-phase current source or by a pulsed direct current.

27. The stator according to claim 1, wherein it has a diameter in the range between 40 and 80 mm or between 40 and 160 mm or between 40 and 200 mm.

28. The stator according to claim 1, wherein it is designed for a power range between 300W and 2 kW or between 300W and 4 kW or between 300W and 6 kW.
